(19) United States
(12) Patent Application Publication
(10) Pub. No.: US 2026/0113318 A1
(43) Pub. Date: Apr. 23, 2026

(54) SYSTEM AND METHOD FOR AUTHENTICATION OF A TRANSMITTER DEVICE WITH A SENSOR AT A RECEIVER DEVICE

(71) Applicant: TrustNXT GmbH, Hamburg (DE)

(72) Inventor: Sebastian Adank, Ahrensburg (DE)

(21) Appl. No.: 19/359,011

(22) Filed: Oct. 15, 2025

(30) Foreign Application Priority Data
Oct. 18, 2024 (DE) 10 2024 130 332.8

(51) Int. Cl. H04L 9/40

(52) U.S. Cl. CPC H04L 63/0876

(57) ABSTRACT

Authentication of a transmitter device with a sensor at a receiver device comprises activation of the sensor of the transmitter device, capture of sensor data from the sensor by the transmitter device, preparation of the captured sensor data and detection of at least one hardware feature in the prepared sensor data, generation of authentication data as a function of the detected hardware feature, comparison of the authentication data with identification data stored for the transmitter device for obtaining a positive or negative comparative result by an authentication device or receiver device which differs from the transmitter device, and authentication of the transmitter device at a receiver device with a positive comparative result and refusal of authentication in the receiver device with a negative comparative result. The disclosure further relates to a system with a transmitter device, a receiver device and preferably an authentication device, a device that perform the method.

### BACKGROUND

### Technical Field

The present disclosure relates to a method and a system for authentication of transmitter devices by means of sensor data. The disclosure relates in particular to a method for detection and utilization of hardware features, such as sensor errors, for the generation of authentication data and the comparison thereof with stored identification data for secure authentication at a receiver device.

### Description of the Related Art

In the field of authentication technologies, it is common to use different methods for verification of the identity of users. These methods typically comprise the use of data, such as passwords, biometric data such a fingerprints or facial recognition, as well as cryptographic keys. Known systems for the authentication are often based on the reception of the data and the comparison of the data with identification data, which is either stored locally on the apparatus or on a central server. These approaches have proven to be effective in order to prevent unauthorized access to apparatuses and to ensure the security of communication systems.

Access to various apparatuses including monitoring cameras is thus permitted only to authorized persons with the mentioned authentication technologies. However, in the case of these methods, only the authentication of the user with the apparatus takes place. However, the apparatus itself usually does not authenticate itself with the user. In the example of monitoring cameras, the user therefore relies on the image displayed to the user, which shows, for instance, a region to be monitored, which the user knows, so that the user trusts the apparatus even without authentication.

However, especially due to the most recent technological developments in the field of artificial intelligence, there is an increasing risk that image, video and audio data with almost any contents can be generated or that existing image, video and audio data can be falsified. In keeping with the above-mentioned example of the monitoring camera, it is possible, for example, to manipulate a spied-out image or video file, which displays an environment known to a user, with additional contents or artificially generated image movements, so that the user cannot differentiate them from the currently captured video data. There is thus the risk that a user sees an artificially generated image or video instead of a live image or video from a monitoring camera.

In order to solve this last mentioned problem, apparatuses are also offered, which transmit data encrypted, for instance, via SSL encryption. However, a manufacturer has to provide a certificate from a trusted certificate authority for such apparatuses. This creates additional work for the manufacturer. The costs for providing a certificate for such apparatuses thus correspond to a large share of the total costs and can even correspond to a higher share of the total costs than the production costs, in particular when such apparatuses can be produced cost-efficiently.

The comparatively higher costs for providing a secure transmission thus have the result that apparatuses, such as the mentioned monitoring cameras, which support an unencrypted transmission of the data and which are thus prone to the mentioned problem, are predominantly used.

In the priority-establishing German patent application, the German Patent and Trademark Office has found the following documents: DE 102019134703 A1 and WO 2023/016682 A1.

### BRIEF SUMMARY AND INITIAL DESCRIPTION

The present disclosure provides a method for the reliable communication between apparatuses which is cost efficient and which offers an alternative for known methods. In particular, a method for authentication of a transmitter device is to be found, which overcomes one or several of the disadvantages of the known authentication methods.

For this purpose, the present disclosure relates to a method for authentication of a transmitter device. Further advantageous embodiments furthermore are provided in the following description.

According to the disclosure, a method for authentication of a transmitter device with a sensor at a receiver device is proposed, which comprises several steps. In one step of the method, a sensor of a transmitter device is preferably activated, wherein this can in particular be an image sensor. The sensor can also be formed as microphone or biometric sensor, such as a fingerprint sensor. In general, a transmitter device preferably describes a device here, which has a sensor and which is configured, for example, for transmitting data, which originates from the sensor, to a further device. The term transmitter device does not rule out that the transmitter device is also configured to receive data from a further device. The transmission can hereby be wired or wireless, for example, so that the transmitter device has, for example, a mobile radio interface, Ethernet interface or generally an interface for the connection to a further device via an internal or public network, such as the Internet. It can also be provided, for example, that the transmitter device and the receiver device are part of a single unit, such as of a computer, so that the transmission is an internal transmission. However, transmitter device and receiver device are preferably arranged in different units and can preferably be locally separated.

By means of the activation of the sensor, the capture of sensor data is made possible, which is subsequently collected by the transmitter device. This sensor data is then prepared in order to get it ready for the further processing. The preparation can comprise one or several preparation steps. The preparation step or steps can be performed in the transmitter device. The preparation step or steps can also be performed in a receiver device, after the transmitter device has transmitted the captured sensor data to the receiver device. Several preparation steps or partial preparation steps can also be provided, wherein one or several of these partial preparation steps are performed in the transmitter device and one or several of these partial preparation steps are performed in the receiver device after transmission of the partially prepared sensor data from the transmitter device to the receiver device.

The sensor can also be referred to as sensor unit. According to the present disclosure, a sensor, thus the sensor unit, therefore comprises at least one electronic component part, such as a detector, sensor or probe, which converts physical or chemical properties or a nature of its environment into electrical signals. However, the sensor, thus the sensor unit, additionally also preferably comprises a processing electronics, such as integrated, microelectronic or electronic circuits, digital signal processors (DSP), amplifiers or converters, which further processes the electrical signals. However, sensor signals can refer to the converted electrical signals, which are also referred to as raw data, and accordingly also refer to signals, which are provided after processing of the raw data by the last downstream processing electronics. Sensor signals or the sensor signals prepared after one or several preparation steps, can therefore also be those signals, which have been transmitted, for example, by a wireless transmission, for example via radio, and which have been processed or prepared by the transmission thereof, namely the transmitting and receiving hardware.

According to a further step of the method, at least one hardware feature, such as, for instance, a sensor feature, for example a sensor error, is detected in the prepared sensor data. These features can be specific irregularities or characteristic properties of the sensor, comprising the hardware processing the sensor signals, which can be used for identification of the transmitter device. Hardware features thus correspond to those features, which are specific for the sensor, comprising the hardware processing the sensor signals, which can be detected and identified in the sensor signals, thus the data from the sensor, during the generation and processing of the sensor signals. A faulty component part, such as a defective transistor, in an electronic circuit, which changes the initial data from the electronic circuit in such a way that said initial data is characteristic for exactly this electronic circuit, is an example for a sensor feature. Pixel errors or noise peaks can be an indication for the hardware feature. Here, a detection of a hardware feature preferably does not inevitably comprise that exactly that component or that component part is identified, from which a characteristic property of the sensor data results. On the contrary, the detection of a hardware feature preferably comprises the detection of an abnormality or irregularity in the sensor data or prepared sensor data, which is recurring and which is to be regarded as indication for a hardware error or a behavior of a hardware, which deviates from the standard.

As a function of the detected hardware feature, authentication data is generated, which is then compared with stored identification data from the transmitter device. This comparison takes place by means of an authentication device or receiver device, which differs from the transmitter device, in order to obtain a comparative result, which can either be positive or negative. The identification data required for the comparison is therefore either present in the authentication device or receiver device, in that it is stored there, for example in a memory. A comparison of the authentication data with identification data stored for the transmitter device can also be understood as verification of the authentication data with the identification data. The comparison therefore comprises a checking, whether the authentication data corresponds to such data, which is expected in consideration of the identification data.

A positive comparative result therefore corresponds, for example, to a successful verification or that the authentication data corresponds to such data, which is expected in consideration of the identification data. This thus does not mean that there has to be a complete correspondence of the identification with the authentication data, preferably a correspondence above a predefined threshold value, for instance above 50% or 70% of the comparable features of identification data and authentication data, is sufficient. The authentication data has to at least fulfill a predefined minimum characteristic, which is or will be specified based on the identification data. A negative comparative result therefore corresponds, for example, to an unsuccessful verification or that the authentication data deviates from such data, which is expected in consideration of the identification data. For example, an unsuccessful verification is therefore assumed when a correspondence lies below or also only slightly below the predefined threshold value, for instance below 50% or 70% of the comparable features of identification data and authentication data, or when the authentication data does not fulfill the predefined minimum characteristic.

In the case of a positive comparative result, the transmitter device is authenticated at the receiver device, while in the case of a negative comparative result, the authentication is refused or cannot be performed.

The identity of a transmitter device and in particular also the sensor data from the transmitter device becomes uniquely identifiably by means of the method. It can therefore be ensured that sensor data, such as image data, which originates from a transmitter device, such as, for example, a monitoring camera, does in fact originate from this transmitter device. A user, who accesses the transmitter device by means of a receiver device, can thus ensure that image or video data originates from a certain transmitter device.

The method can also be used, for example, during an existing video conference, when a first user, who uses the transmitter device as first subscriber device for the video conference, and a second user, who uses the receiver device as second subscriber device for the video conference, can mutually exchange video and audio data. In the beginning or while the transmitter device transmits the video data stream to the receiver device, the authentication data can be generated, for example, in the receiver device, from the prepared sensor data received by means of the receiver device and can be compared with the identification data stored in the receiver device.

The authentication of the transmitter device, thus a verification that it is a specific transmitter device, can thus take place, for example parallel to the transmission of the video data stream from the transmitter device to the receiver device, without additional data having to be transmitted.

The method ensures that current and relevant data is used. The preparation of the sensor data and the detection of hardware features provide for a precise identification of the transmitter device. The generation of authentication data as a function of specific hardware features provides for the authentication on the basis of unique features, which are hard to falsify. The comparison of the authentication data with stored identification data can provide for a more exact and more reliable authentication. As a whole, this method can contribute to improving the security and integrity of the communication between transmitter device and receiver device, in that it ensures that only authorized apparatuses are authenticated.

The activation of the sensor, in particular of an image sensor, of the transmitter device, represents the first step in the authentication process. The sensor is hereby activated by a signal or a command from the transmitter device in order to be put into an operational state. This step is necessary in order to prepare the sensor for the capture of sensor data.

The capture of sensor data from the sensor by the transmitter device takes place, for example, directly after the activation of the sensor. The transmitter device thereby collects the data generated by the sensor, which can include different information, such as, for example, image data or other relevant sensor measuring values. This data is captured, for instance, in a raw format and is provided for the further processing.

The preparation of the captured sensor data includes, for example, the processing and conversion of the raw data into a usable format. This step can comprise different methods, such as the filtering of noise, the correction of distortions or the extraction of relevant features. The goal is to present the sensor data in a form, which is suitable for the subsequent steps of the authentication process.

The detection of at least one hardware feature, such as a sensor error, in the prepared sensor data corresponds to a step in which the prepared data is analyzed in order to identify specific features or anomalies. A hardware feature could be, for example, an error in an image point of the image sensor, which would not occur in the case of a manipulation, an attempted emulation or an exchange of the sensor. This error would therefore be crucial for the subsequent generation of the authentication data.

The generation of authentication data as a function of the detected hardware feature takes place on the basis of the previously identified features. The authentication data is specific information, which is to confirm the integrity and authenticity of the sensor data. This data is generated by the transmitter device, the receiver device itself or in an authentication device, which represents a third instance in addition to the transmitter device and the receiver device, and can include cryptographic signatures or other security features.

The comparison of the authentication data with identification data stored for the transmitter device for obtaining a positive or negative comparative result is carried out by an authentication device or receiver device, which differs from the transmitter device. In this step, the generated authentication data is compared with previously stored identification data in order to preferably verify the genuineness of the sensor data. The result of this comparison can either be positive or negative, depending on whether the data corresponds.

The authentication of the transmitter device at a receiver device in the case of a positive comparative result and refusal of an authentication in the receiver device in the case of a negative comparative result forms the final step of the method. In the case of a positive comparative result, the transmitter device is acknowledged as being authentic and the communication or a secured data exchange, such as a secured data storage, with the receiver device is preferably permitted or an indication about the acknowledged authenticity is provided to a user of the receiver device. In the case of a negative comparative result, the authentication is refused, which suggests that the sensor data may have been manipulated, may not be identical or may be unreliable.

According to a first embodiment, in particular when the comparison of the authentication data is performed with identification data stored for the transmitter device for obtaining a positive or negative comparative result with the receiver device, the method comprises, after the generation of the authentication data and prior to the comparison, reception of the identification data for the transmitter device from an authentication device, which corresponds, for example, to a trusted certificate authority or a trusted certificate server. After an inquiry, which is transmitted from the receiver device to the authentication device, identification data is preferably transmitted from the authentication device to the receiver device. The inquiry particularly preferably comprises an identifier of the transmitter device, which is transmitted, for example, from the transmitter device to the receiver device.

According to one embodiment, the prepared sensor data is transmitted from the transmitter device to the authentication device, wherein the authentication device generates the authentication data and compares it with the identification data in order to obtain the comparative result. For this purpose, the identification data is preferably already stored in the authentication device or can be retrieved by the latter. This communication structure provides for a direct and possibly quicker processing of the sensor data by the authentication device, which can increase the efficiency of the authentication process.

A further embodiment provides that the prepared sensor data is transmitted from the transmitter device to the receiver device and from there to the authentication device, wherein the authentication device generates the authentication data and compares it with the identification data in order to obtain the comparative result. In this case, the identification data is preferably also already stored in the authentication device or can be retrieved by the latter. This method can offer additional security layers because the receiver device acts as intermediate station and can possibly perform a first checking or filtering of the sensor data before the latter is transferred to the authentication device.

A further embodiment comprises that the prepared sensor data is transmitted from the transmitter device to the receiver device, wherein the receiver device generates the authentication data and then transmits the latter to the authentication device. The comparison is then likewise performed in the authentication device in order to obtain the comparative result. The identification data, in turn, is preferably already stored in the authentication device or can be retrieved by the latter. This variation could shift the burden of the data processing to the receiver device and could relieve the authentication device, which can lead to a better distribution of the computational resources.

According to a further embodiment, the authentication data is generated from the prepared sensor data in the transmitter device and is transmitted to the authentication device, the receiver device or the receiver device for transferring to the authentication device. This method could increase the efficiency of the entire system because the transmitter device directly generates the authentication data and thus reduces the necessity of a further data processing by other components.

In addition, an embodiment is comprised, in the case of which the prepared sensor data is transmitted from the transmitter device to the receiver device and the receiver device generates the authentication data and compares it with the identification data in order to obtain the comparative result. In this case, the identification data is preferably already stored in the receiver device or can be retrieved by the latter. This variation could increase the security and integrity of the authentication data because the receiver device directly processes the data and potential manipulations or errors during the transfer between several apparatuses are thus minimized. An additional authentication device can furthermore be forgone.

As a whole, these different embodiments offer flexible and adaptable mechanisms for communication and processing of sensor data in order to design the authentication of the transmitter device at the receiver device in an efficient and secure manner. The specific mechanisms of the communication between the components contribute to optimizing the authentication processes, in that they consider different requirements for security, speed and use of resources.

According to a further embodiment, the method comprises outputting of a request, for example of a visual or auditive request, preferably by the transmitter device, in particular a display or a loudspeaker, of the transmitter device. The request is preferably a request for a user to perform a specific gesture, such as, for instance, a dimming of a sensor formed as image sensor, for example by hand or with a finger, or to make a certain sound, such as clapping. With the request, an attempt is made to get the user to bring the sensor into a specific or predefined recording situation, in which hardware features can be detected better or quicker. The method can thus be improved or accelerated.

According to a further embodiment, the method for authentication of a transmitter device with a sensor at a receiver device is expanded and clarified by specific mechanisms of communication between the components. The sensor, which is used in this embodiment, is an image sensor. For example, the image sensor corresponds to a CCD sensor or another sensor for recording two-dimensional images. However, the image sensor can also be formed for recording three-dimensional images, and can correspond to a Lidar sensor, a PMD sensor (photonic mixing device) of a TOF camera, which can also be referred to as time-of-flight camera, or as sensors of a stereo camera comprising several sensor elements. In any case, the provided sensor data, which is captured by the transmitter device, corresponds to image data or video data. Such data can correspond to two-dimensional image data but also to point clouds or other three-dimensional image data. This image data or video data represents at least one image recorded by means of the image sensor, a video sequency recorded by means of the image sensor or a video stream recorded continuously by means of the image sensor. A video sequence hereby preferably comprises a time-limited range of images or frames recorded by means of the image sensor. A video stream preferably comprises a continuous recording of images or frames captured by means of the image sensor. The prepared sensor data thus corresponds to prepared image data or prepared video data.

The use of an image sensor provides for a detailed capture of visual information, which can be used for the authentication. Image data and video data offer an abundant source of information, which can be used for detection of hardware features, such as sensor errors. Specific features can be extracted and analyzed by means of the preparation of this data, which increases the accuracy and reliability of the authentication process. A continuous recording of video data provides for a real-time monitoring and authentication, which is advantageous especially in safety-critical applications. The continuous recording of data ensures that the authentication data is always up to date and is based on the latest information. The processing and preparation of the image and video data further improves the efficiency of the method because only relevant and processed data is used for the authentication. This reduces the data quantity, which has to be transmitted and analyzed, and accelerates the entire authentication process.

The use of image and video data furthermore provides for a versatile application of the method in different fields, such as access control, monitoring and videotelephony. The precise detection and analysis of hardware features in image and video data significantly increases the security and reliability of the authentication process.

According to a further embodiment, the sensor data corresponds to video data. In this case, the prepared sensor data corresponds to prepared video data, which comprises, for example, that the raw data of the sensor is converted into a format, which is suitable for the further processing and analysis. The preparation can furthermore also comprise further processing steps.

The prepared video data comprises several video frames, which form a video sequence or a video stream, wherein the video frames are arranged in a certain order. This is of crucial importance because the order of the frames provides information about the chronological order and the integrity of the video data. The prepared video data furthermore comprises sequence test data, which is preferably embedded as additional data, such as metadata or headers, in order to ensure the integrity and authenticity of the video sequence. The sequence test data can preferably also be added into the individual frames in the manner of a block chain. Such a method is also referred to as image chaining and comprises the continuous hashing of image series.

The sequence test data is used for verification of the order of each of the video frames in order to ensure that the video frames are present in the correct order and that a manipulation or data loss has not taken place. Additionally or alternatively, the sequence test data is used for verifying the affiliation of each of the video frames with the prepared video data in the authentication device or receiver device. This means that each frame is checked as to whether it is in fact part of the original video sequence, which provides an additional security layer in order to ensure that the video data has not been changed or falsified. These mechanisms of communication between the components contribute significantly to the security and reliability of the authentication method, in that they ensure that the video data is authentic and unchanged in its order as well as in its affiliation. Due to the implementation of these additional features, the method becomes more robust against manipulation attempts and data corruption, which increases the trustworthiness and security of the entire authentication solution.

According to a further embodiment, the sensor is a microphone, whereby the sensor data is specified as audio data. This audio data represents at least one audio sequence recorded by means of the microphone or an audio stream recorded by means of the microphone, which clarifies the type of the captured data and expands the range of application of the method. An audio sequence hereby preferably comprises a time-limited range of sounds recorded by means of the microphone. An audio stream preferably comprises a continuous recording of sounds captured by means of the microphone. The prepared sensor data thus corresponds to prepared audio data, which comprises several audio frames forming the audio sequence or the audio stream with a specific order as well as sequence test data. For example, a frequency spectrum at a point in time can be referred to as audio frame. The sequence test data serves the purpose of verifying the order of each of the audio frames in the prepared audio data and/or the affiliation of each of the audio frames with the prepared audio data in the authentication device or receiver device.

With the formation of the sensor as microphone and the definition of the sensor data as audio data, a new dimension of authentication is opened up, which is relevant in particular for applications in the field of speech and audio recognition. The use of audio frames and sequence test data ensures that the integrity and authenticity of the captured audio data is ensured in that the correct order and affiliation of the audio frames is checked. This increases the security of the authentication method because manipulations or unauthorized changes to the audio data can be detected more easily. The sequence test data provides for a precise verification of the audio data, which is significant especially in safety-critical applications.

The use of audio data additionally opens up new possibilities for the authentication in environments, in which visual data is not available or is not sufficient. The described mechanisms of communication between the components, in particular the verification of the order and affiliation of the audio frames, contribute significantly to increasing the reliability and security of the authentication method and expand the range of application thereof.

According to a further embodiment, the detection of at least one hardware feature in the prepared sensor data comprises a detection of at least one physical feature or error of the sensor. Specific physical features or errors of the sensor, such as, for example, one or several RTN errors (random telegraph noise) are therefore considered. RTN errors are characteristic noise patterns, which can occur in the sensor data and which serve as unique identifiers. The detection of these physical features or errors is based on the prepared sensor data, which means that the data is initially processed by the transmitter device and is brought into a form, which provides for the detection of such features. This prepared sensor data can in particular be prepared video data or audio data, which increases the flexibility and applicability of the method for different types of sensors. With the inclusion of video data or audio data as prepared sensor data, the method is not only limited to image sensors but can also be applied to other sensors, which capture visual or auditive information. This significantly expands the application spectrum of the method and provides for the authentication in a plurality of scenarios, in which different sensor types are used. By detecting physical features of the sensors, the robustness and reliability of the authentication process in increased. It is ensured that the authentication data is based on specific physical properties of the sensor, which is difficult to falsify. This makes it significantly more difficult for potential hackers to bypass the authentication because they do not only have to imitate the captured sensor data but also the specific physical features or errors of the sensor. As a whole, the security and accuracy of the authentication method is thus improved because the authentication data can be generated based on the unique physical properties of the sensor.

According to a further embodiment, the preparation of the captured sensor data takes place in the transmitter device and/or the receiver device and/or the authentication device. This distribution of the preparation processes provides for a flexible and efficient processing of the sensor data, in that it distributes the computational load to several components and thus optimizes the overall performance of the system.

The preparation of the captured sensor data comprises the selection of at least one part of the sensor data, in particular of at least one image range of an image recorded by means of the sensor. This provides for a targeted analysis and processing of specific data ranges, whereby the accuracy and relevance of the authentication data is increased.

Alternatively or additionally, the preparation of the captured sensor data comprises the selection of at least one sequence section, thus a sequence, and/or of at least one image range of a video sequence recorded by means of the sensor. This method allows for a precise extraction of relevant information from video data, which is particularly useful when only certain parts of a video sequence are relevant for the authentication. Such a selection additionally serves the purpose of reducing the data for the further processing or transmission. This selection preferably takes place in the receiver device, to which all of the video data is supplied, for example in the form of a video call, and which then only uses selected, for example particularly relevant, parts of the video data for the authentication process, thus the generation of authentication data.

Alternatively or additionally, the preparation of the captured sensor data comprises the selection of a sequence section, thus a sequence, and/or frequency range of an audio sequence recorded by means of the sensor. This function makes it possible to focus on specific audio segments or frequency ranges, which could be crucial for the authentication, and thus contributes to the improvement of the authentication accuracy. Such a selection additionally serves the purpose of reducing the data for the further processing or transmission. This selection also preferably takes place in the receiver device, to which all of the video data is supplied, for example in the form of an audio call, and which then only uses selected, for example particularly relevant, parts of the audio data for the authentication process, thus the generation of authentication data.

Alternatively or additionally, the preparation of the captured sensor data comprises the filtering, in particular noise filtering, of the sensor data. Unwanted interference and noise are removed by means of the filtering of the sensor data, which leads to a clearer and more precise data basis for the authentication. The filtering preferably takes place in the transmitter device.

The option of distributing the preparation of the sensor data to different components provides for an improved use of resources and can increase the processing speed. With the targeted selection and filtering of specific data ranges, the relevance of the analyzed data is maximized, which leads to a higher accuracy of the authentication and/or to the reduction of the data to be transmitted. As a whole, these features contribute to making the method more robust and more adaptable to different application scenarios.

According to a further embodiment, the sensor or a further sensor of the transmitter device corresponds to a biometric sensor, in particular the image sensor or a further image sensor or a fingerprint sensor. This means that the transmitter device is able to capture biometric data, which provides for a higher security and accuracy in the authentication. The method comprises the generation of biometric data by means of the biometric sensor, which means that the transmitter device prepares the captured biometric data and provides it for the authentication. This biometric data is then transmitted from the transmitter device to the receiver device and/or the authentication device. This transmission can take place via different communication protocols, such as, for example, wireless networks, Bluetooth or other secure communication channels, in order to ensure that the data integrity and confidentiality is maintained.

The method furthermore comprises the verification of the biometric data by means of the receiver device and/or the authentication device as a function of the identification data. This means that the received biometric data is compared with previously stored identification data in order to confirm the authenticity of the transmitter device or the authenticity of the transmitter device and additionally of a user of the transmitter device.

The comparison of the biometric data increases the security of the authentication method because biometric features, such as fingerprints or facial recognition data is more difficult to falsify than conventional passwords or PINs. The security of the authentication method is further improved with this embodiment, in that the use of biometric data is integrated.

According to a further embodiment, the method comprises a reception or read-out of a selection parameter or of a password. The preparation of the captured sensor data and/or the detection of the hardware feature and/or a sensor selection of the transmitter device further takes place as a function of the received selection parameter or the received password. This provides for a dynamic adaptation of the authentication process. This means that, for example, the receiver device and/or the authentication device is able to select specific sensor data or specific sensors of the transmitter device, wherein the transmitter device generates corresponding data based on the received parameters or passwords and provides it as sensor data or prepared sensor data for the receiver device.

According to a further embodiment, the selection parameter is received by an input apparatus for a user, in particular the receiver device.

According to a further embodiment, exactly that sensor is selected, which is defined by the selection parameter, in order to capture the sensor data from the selected sensor and in order to supply exactly this sensor data to the further steps of the method, in particular to steps c) to g), in particular in the case that the receiver device comprises several sensors and a selection parameter comprises a sensor selection of one of the several sensors.

According to a further embodiment, for example a range, a part, a sequence and/or a frequency range of the sensor data, which is defined by the selection parameter, is selected for the further processing, in particular in order to detect the hardware parameter in the selection, in particular in the case that the selection parameter comprises instructions for the step of the preparation of the captured sensor data.

According to a further embodiment, the further processing, namely the detection for exactly that physical, which is identified by the selection parameter, is carried out, in particular in the case that the selection parameter comprises instructions for the step of the detection of the hardware feature, for example a definition of the physical feature, which is defined by the selection parameter.

This embodiment preferably comprises the reception of several selection parameters. One or several of the steps of the authentication method are in each case performed with the received selection parameters, which means that the received parameters can directly influence the performance of the individual steps. This could mean, for example, that certain sensor data is only prepared or that certain hardware features are only detected when specific selection parameters have been received. As a whole, these new features bring an increased security and flexibility to the authentication process, in that they make it possible that the transmitter device can react dynamically to different parameters and that a more precise and more adaptable authentication is thus ensured.

This is particularly relevant in scenarios, in which different security requirements or variable environmental conditions are present, which require a flexible adaptation of the authentication process.

According to a further embodiment, several selection parameters are stored or can be generated in the authentication device or the receiver device. These selection parameters can comprise different criteria and conditions, as they are listed, for example, in the above-mentioned embodiment. The steps of the method, in particular the activation of the sensor, the capture and preparation of the sensor data and/or the detection of hardware features and the generation of authentication data, are in each case assigned to at least one of these selection parameters and are performed.

A separate authentication loop is preferably passed through for each selection parameter, so that a challenge-response method is implemented. A selection parameter is thus preferably received by the transmitter device and sensor data or prepared sensor data is then provided as a function of the selection parameter. The next selection parameter is then received from the transmitter device and further sensor data or further prepared sensor data is provided as a function of the next selection parameter. This continues for a predefined number of selection parameters.

In the step of the comparison of the authentication data with the stored identification data, the transmitter device is only authenticated in the receiver device when a positive comparative result has been detected in all performed authentication loops. Otherwise, the authentication is refused in the receiver device.

The security of the authentication method is thus further increased because several independent parameters are considered, which reduces the probability of a successful hacking or of an error identification. In addition, the flexibility of the system is increased because it is possible to define and to implement specific authentication requirements for different application scenarios. With the consideration of several selection parameters and the performance of the authentication steps for each of these parameters, a high degree of security and reliability is achieved, which makes the method particularly suitable for the use in safety-relevant fields.

According to a further embodiment, identification data is provided prior to the first performance of the steps of the method, which means that this data has to be made available beforehand in order to be able to carry out the comparison and the authentication at all. This identification data can include specific information about the transmitter device, which is relevant for the authentication device and/or the receiver device. With the provision of the identification data prior to the comparison process, it is ensured that the authentication device or the receiver device have the required information in order to check the authenticity of the transmitter device. This increases the security and reliability of the authentication process because the comparative data is already present and does not have to be first collected during the authentication process. The identification can comprise, for example, specific sensor characteristics of the sensor or of the sensors or other unique features of the transmitter device, which make it possible to uniquely identify the transmitter device. With the provision of this data, comparative data is already validated and stored beforehand. This reduces the probability of errors or manipulations during the authentication process.

In addition, the system comprises a transmitter device, a receiver device and preferably an authentication device, wherein the system is configured to carry out the method for authentication of a transmitter device with a sensor at a receiver device.

The transmitter device, equipped with a sensor, in particular an image sensor, is activated in order to capture sensor data. This data is subsequently prepared and analyzed in order to detect at least one hardware feature, such as a sensor error. The authentication data, which is generated as a function of the detected hardware feature, is then compared with the stored identification data from the transmitter device. This comparison can either be carried out by the receiver device or a separate authentication device in order to obtain a positive or negative comparative result. In the case of a positive comparative result, the transmitter device is authenticated at the receiver device, while the authentication is refused in the case of a negative comparative result. The integration of an authentication device into the system offers additional security because it represents an independent instance, which checks the authentication data and thus prevents manipulations or unauthorized access.

In addition, the present disclosure relates to a device, which is configured specifically for performing the steps of the method, which are based on a receiver device, an authentication device or a transmitter device.

If the device is a transmitter device, it is at least configured to perform the steps a) to c). The transmitter device is preferably configured to generate sequence test data and for transmitting the latter with the sensor data or the prepared sensor data. For example, the transmitter device is also configured to receive selection parameters or a password and to carry out the preparation of the sensor data and/or a selection of the sensor for generation of the sensor data as a function of the selection parameter or the password.

If the device is an authentication device, it is at least configured to perform the steps d) to g). The authentication device is preferably configured to store or to retrieve the identification data. For example, the authentication device is also configured to prepare the captured sensor data by selection of at least a part of the sensor data, in particular of at least one image range of an image recorded by means of the sensor, selection of at least one sequence section or of a sequence, and/or of at least one image range of a video sequence recorded by means of the sensor or selection of a sequence section or of a sequence, and/or frequency range of an audio sequence recorded by means of the sensor. The authentication device is further preferably configured to generate or retrieve one or several selection parameters and to transfer it/them to the transmitter device.

If the device is a receiver device, the latter is preferably configured to perform steps d) to g). The receiver device is preferably configured to store or retrieve the identification data. For example, the receiver device is additionally configured to prepare the captured sensor data by selection of at least a part of the sensor data, in particular of at least one image range of an image recorded by means of the sensor, selection of at least one sequence section or of a sequence, and/or of at least one image range of a video sequence recorded by means of the sensor or selection of a sequence section or of a sequence, and/or frequency range of an audio sequence recorded by means of the sensor. The receiver device is further preferably configured to generate or retrieve one or several selection parameters and to transfer it/them to the transmitter device. The receiver device is preferably also configured to exchange data with the transmitter device and/or the authentication device.

In addition, the present disclosure relates to software, which, when it is run by means of a processor, prompts the processor to perform the steps of the method, which are based on a system, a receiver device, an authentication device or a transmitter device.

### BRIEF DESCRIPTION OF THE SEVERAL VIEWS OF THE DRAWINGS

Further embodiments follow on the basis of the exemplary embodiments, which are explained in detail in the figures, in which:

FIG. 1 shows a system according to an exemplary embodiment,

FIG. 2 shows the steps of the method according to an exemplary embodiment, and

FIG. 3 shows the method according to a further exemplary embodiment.

### DETAILED DESCRIPTION

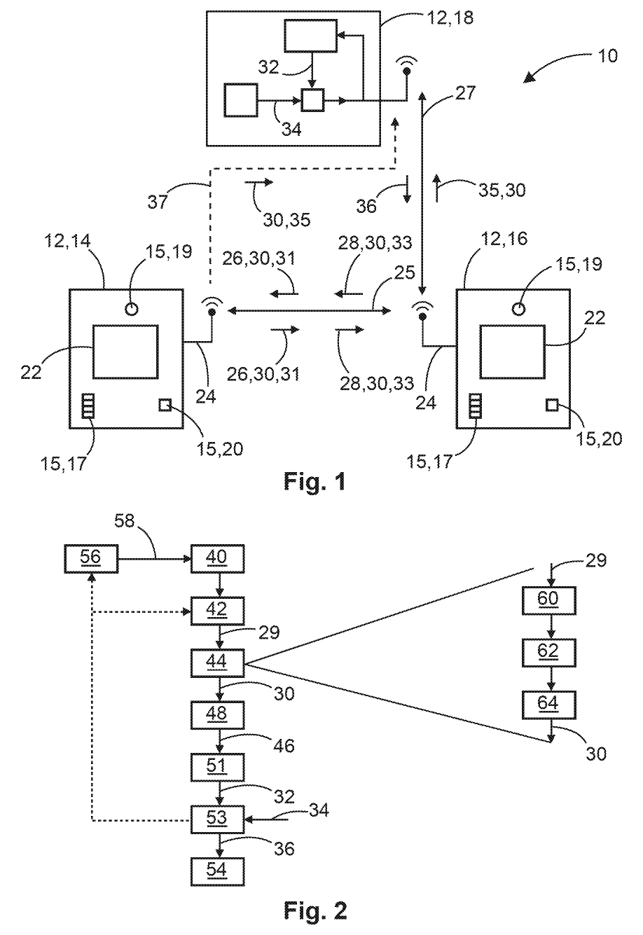

FIG. 1 shows a system 10 according to an exemplary embodiment of the present disclosure. The system 10 comprises three devices 12, which are configured to carry out the method according to an exemplary embodiment. One of the devices 12 corresponds to a transmitter device 14, a further one of the devices 12 corresponds to a receiver device 16 and a further one of the devices 12 corresponds to an authentication device 18.

The transmitter device 14 and the receiver device 16 comprise several sensors 15. The transmitter device 14 and the receiver device 16 therefore each have a sensor 15 formed as microphone 17, a sensor 15 formed as front facing camera 19 and a sensor 15 formed as biometric sensor 20, for example as fingerprint sensor. The front facing camera 19 comprises or corresponds to an image sensor, which can also be referred to as video sensor. In addition, the transmitter device 14 as well as the receiver device 16 each comprise a display 22.

The transmitter device 14 and the receiver device 16 further each have a wireless interface 24. A data connection 25 between the transmitter device 14 and the receiver device 16 can be established by means of the wireless interfaces 24 in order to exchange data with one another via the data connection 25. The authentication device 18 also comprises such a data interface 24. A further data connection 27 can thus be provided between the receiver device 16 and the authentication device 18.

The transmitter device 14 and the receiver device 16 are designed, for example, to carry out a videotelephony. This means that video data 26, which is provided by means of the front facing camera 19 of the transmitter device 14 and which is preferably prepared by the transmitter device 14, as well as audio data 28, which is provided by means of the microphone 17 of the transmitter device 14 and which is preferably prepared by the transmitter device 14, can be transmitted via the data connection 25 to the receiver device 16 for representation by means of the display 22. Such prepared video data 26 and prepared audio data 28 can therefore also be transferred from the receiver device 16 to the transmitter device 14 for representation by means of the display 22 of the transmitter device 14. The prepared video data 26 and the prepared sensor data can each also generally be referred to as prepared sensor data 30.

The transmitter device 14 and the receiver device 16 are thus preferably formed essentially identically. The transmitter device 14 and the receiver device 16 can each correspond, for example, to a standardized mobile telephone or a portable computer, on which a computer program product according to the disclosure is run in order to perform the steps of the method.

For example, video data 26, which is continuously prepared after the beginning of a videotelephony to the end of a videotelephony and which corresponds to a video stream 31, and prepared audio data 28, which corresponds to an audio stream 33, is therefore exchanged, for example, between the transmitter device 14 and the receiver device 16.

In particular the prepared sensor data 30 received by means of the receiver device 16, which corresponds, for example, to prepared video data 26, is further processed in the receiver device 16 and is used, for example, for the representation by means of the display 22 of the receiver device 16. The further processing can also comprise a further preparation, in the case of which a part of the prepared sensor data 30, namely a sequence 35, including a part of the prepared video data, which can also be referred to as sequence of video frames or as video sequence, in short, is extracted from the prepared sensor data 30.

The prepared sensor data 30 or the sequence 35 is then transferred to the authentication device 18. The authentication device 18 determines authentication data 32 from the prepared sensor data 30 or the sequence 35. For determination of the authentication data 32, hardware features of the sensor 15, by means of which the prepared sensor data 30 was provided, such as, for example by means of the front facing camera 19, is detected in the prepared sensor data 30, such as, for example, the prepared video data 28. For example, the authentication data 32 is generated based on so-called physically unclonable functions (PUFs), which can be taken from the prepared video data 28.

The authentication data 32 is compared with identification data 34 stored for the transmitter device 14 and the transmitter device 14 is authenticated at the receiver device 16 via an authentication message, which comprises a comparative result 36, in the case that the authentication data 32 matches the identification data 34.

According to an alternative exemplary embodiment not illustrated here, the prepared sensor data 30 is transmitted to the receiver device 16 by the transmitter device 14 and at least a part of the prepared sensor data 30, such as, for example, a sequence, is simultaneously transmitted directly to the authentication device 18 via a third data connection 37, which is only illustrated as dashed line. By means of the authentication message, comprising the comparative result 36, the authentication device 18 then accordingly authenticates the transmitter device 14 directly at the receiver device 16. According to a further exemplary embodiment, which is not illustrated here, the authentication device 18 is part of the receiver device 16. The data transmission between the receiver device 16 and the authentication device 18 then corresponds to an internal data transmission within the receiver device 16. According to a further exemplary embodiment, which is not illustrated here, the transmitter device 14 or the authentication device 18 is also configured to authenticate the receiver device 16 in an analogous manner. The third data connection 37 could then likewise be used for this purpose.

FIG. 2 shows the steps of the method according to an exemplary embodiment. In a step 40, a sensor 15 of a receiver device 16 is activated. In step 42, sensor data 29 is captured by means of the sensor 15. In step 44, the captured sensor data 29 is prepared and is output as prepared sensor data 30. In step 48, a hardware feature 46 is detected in the prepared sensor data 30. The hardware feature 46 is then supplied to a step 51, in which authentication data 32 is generated, wherein the authentication data 32 is compared with identification data 34 in a step 53. A comparative result 36 is output as a function of the comparison in step 53 and the transmitter device 14 is authenticated at the receiver device 16 in step 54.

In addition, the method can optionally comprise a further step 56, which comprises the provision of a selection parameter 58. The steps 40 to 54 are then performed as a function of the selection parameter 58 provided in step 56. The selection parameter 58 comprises, for example, a selection of one of several sensors 15 of the transmitter device 14, so that exactly the sensor 15, which is specified by the selection parameter 58, is activated in step 40 during the activation. Sensor data from the selected or activated sensor 15 is accordingly captured in step 42 and said sensor data is prepared in step 44.

According to a further exemplary embodiment, which is clarified in FIG. 2 by means of a dashed line, the step 56 can be performed several times, in that a further selection parameter 58 is specified in step 53, after the comparison in the case of a positive comparative result 36, and the steps are performed again. The step 40 of the activation is optional here and can be skipped when the sensor 15 is already activated.

The preparation in step 44 preferably additional comprises several partial steps, wherein the captured sensor data 29 is filtered in step 60, the filtered sensor data is transmitted from the transmitter device 14 to the receiver device 16 in step 62 and a selection is made in step 64, which comprises, for example, a selection of a sequence 35 of the sensor data. The selection of the sequence 35 of the filtered sensor data then corresponds to the prepared sensor data 30.

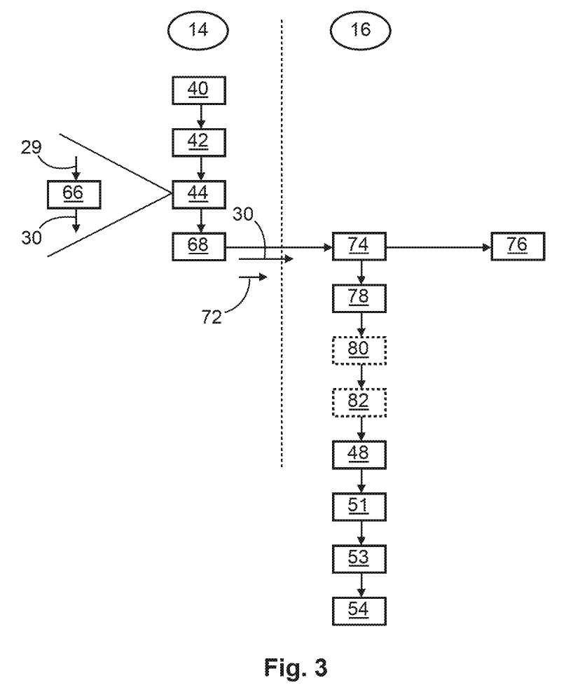

FIG. 3 shows a further exemplary embodiment of the method, wherein the steps are assigned to the transmitter device 14 and the receiver device 16 here. As has already been illustrated in FIG. 2, the transmitter device 14 initially activates a sensor 15 in step 40 and captures the sensor data 29 in step 42. Step 40 is optional and is performed only if the sensor 15 has not been activated yet. The sensor data 29 is prepared in step 44. The preparation 44 can optionally also comprise the generation of sequence test data 72 and addition of the sequence test data 72 to the prepared sensor data 30 in a step 66. The prepared sensor data 30 is then transmitted from the transmitter device 14 to the receiver device 16, optionally with sequence test data 72, in step 68.

The prepared sensor data 30 is received by the receiver device 16 in step 74 and said sensor data is reproduced after further processing in step 76. The prepared sensor data 30, if it corresponds, for example, to prepared video data 26, is simultaneously supplied to a step 78, in which a sequence 35 is extracted. Steps 80 and 82 are optional and are only performed if the prepared sensor data 30 comprises sequence test data 35. The sequence test data is extracted from the prepared sensor data 30 in step 80 and the order of video frames in the prepared video data 26 is tested in the sequence 35 in step 82. A hardware feature 46 of the sensor 15, which corresponds to the activated sensor 15 of the transmitter device 14, in the sequence 35 is then detected in further step 48. Authentication data 32 is generated as a function of the hardware features in step 51. The authentication data 32 is then compared with identification data 34 in step 53 and a comparative result 36 is generated in order to authenticate the receiver device 16 in the case of a positive comparative result 36 in step 54 or to deny an authentication, thus to refuse it in the case of a negative comparative result 36.

### LIST OF REFERENCE NUMERALS

10 system

12 devices

14 transmitter device

15 sensors

16 receiver device

17 microphone

18 authentication device

19 front facing camera

20 biometric sensor

22 display

24 wireless interface

25 wired connection

26 prepared video data

27 further data connection

28 prepared audio data

29 captured sensor data

30 prepared sensor data

31 video stream

32 authentication data

33 audio stream

34 identification data

35 sequence

36 comparative result

37 third data connection

40 activation of sensor of a receiver device

42 capture of sensor data by means of sensor

44 preparation of the captured sensor data and outputting thereof as prepared sensor data

46 hardware feature

48 detection of hardware feature

51 generation of authentication data

53 outputting of comparative result

53 comparison of authentication data with identification data

54 authentication of transmitter device at the receiver device

56 provision of a selection parameter

58 selection parameter

60 filtering of sensor data

62 transmission of the filtered sensor data from the transmission device to the receiver device

64 making a selection

66 generation of sequence test data and addition of the sequence test data to the prepared sensor data

68 transmission of sensor data from the transmission device to the receiver device

70 video stream

72 sequence test data

74 reception of prepared sensor data

76 reproduction of prepared sensor data

78 extraction of sequence

80 extraction of sequence test data

82 testing order of video frames in the prepared video data

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method for authentication of a transmitter device with a sensor at a receiver device, comprising:
a) activation of the sensor of the transmitter device,
b) capture of sensor data from the sensor by the transmitter device,
c) preparation of the captured sensor data,
d) detection of at least one hardware feature in the prepared sensor data,
e) generation of authentication data as a function of the detected hardware feature,
f) comparison of the authentication data with identification data stored for the transmitter device for obtaining a positive or negative comparative result by an authentication device or receiver device which differs from the transmitter device, and
g) authentication of the transmitter device at a receiver device in the case of a positive comparative result and refusal of an authentication at the receiver device in the case of a negative comparative result.

2. The method according to claim 1, wherein:
i) the prepared sensor data is transmitted from the transmitter device to the authentication device and the authentication device generates the authentication data and compares it with the identification data; or
ii) the prepared sensor data is transmitted from the transmitter device to the receiver device and from the receiver device to the authentication device and the authentication device generates the authentication data and compares it with the identification data.

3. The method according to claim 1, wherein:
iii) the prepared sensor data is transmitted from the transmitter device to the receiver device, the receiver device generates the authentication data and the authentication data is transmitted to the authentication device from the receiver device, wherein the authentication device compares the authentication data with the identification data; or
iv) the authentication data is generated from the prepared sensor data in the transmitter device and is transmitted to the authentication device, the receiver device or the receiver device for transfer to the authentication device, wherein the authentication device compares the authentication data with the identification data; or
v) the prepared sensor data is transmitted from the transmitter device to the receiver device and the receiver device generates the authentication data and compares it with the identification data.

4. The method according to claim 1, wherein the sensor is an image sensor and the captured sensor data corresponds to image data or video data which represents at least one image recorded by the image sensor, a video sequence recorded by the image sensor, or a video stream recorded continuously by the image sensor, and the prepared sensor data corresponds to prepared image data or prepared video data.

5. The method according to claim 4, wherein the sensor data corresponds to video data and the prepared sensor data corresponds to prepared video data, wherein the prepared video data comprises several video frames which form the video sequence or the video stream with an order as well as test sequence data, wherein the test sequence data is used for verification of the order of each of the video frames in the prepared video data and/or the affiliation of each of the video frames with the prepared video data in the authentication device or receiver device.

6. The method according to claim 1, wherein the sensor is a microphone and the captured sensor data corresponds to audio data which represents at least one audio sequence recorded by the microphone or an audio stream recorded by the microphone, and the prepared sensor data corresponds to prepared audio data.

7. The method according to claim 6, wherein the prepared audio data comprises several audio frames forming the audio sequence or the audio stream with an order as well as sequence test data, wherein the sequence test data is used to verify the order of each of the audio frames in the prepared audio data and/or the affiliation of each of the audio frames with the prepared audio data in the authentication device or receiver device.

8. The method according to claim 1, wherein the detection of at least one hardware feature in the prepared sensor data corresponds to the detection of at least one physical feature of the sensor or error of the sensor, based on the prepared sensor data.

9. The method according to claim 8, wherein the at least one physical feature of the sensor or error of the sensor is a random telegraph noise (RTN) error of the sensor.

10. The method according to claim 1, wherein the preparation of the captured sensor data takes place in the transmitter device and/or the receiver device and/or the authentication device.

11. The method of claim 10, wherein the preparation of the captured sensor data comprises a selection:
of at least a part of the sensor data;
of at least one sequence and/or of at least one image range of a video sequence recorded by the sensor;
of a sequence and/or frequency range of an audio sequence recorded by the sensor; and/or
of noise filtering of the sensor data.

12. The method according to claim 1, wherein the sensor or a further sensor of the transmitter device corresponds to a biometric sensor, and the method comprises the generation of biometric data by the biometric sensor, the transmission of the biometric data from the transmitter device to the receiver device and/or the authentication device as well as the verification of the biometric data by the receiver device and/or the authentication device as a function of the identification data.

13. The method according to claim 1, wherein the method comprises the reception or read-out of a selection parameter or of a password and the preparation of the captured sensor data and/or the detection of the hardware feature and/or a sensor selection of the transmitter device takes place as a function of the received selection parameter or the received password.

14. The method according to claim 13, wherein the method comprises the reception of several selection parameters by which one or several of the steps a) to g) are performed in each case.

15. The method according to claim 13, wherein several selection parameters are stored or generated in the authentication device or the receiver device and steps a) to f) and/or c) to f) and/or d) to f) are preferably in each case performed at least once for each of the selection parameters, wherein in step f) the transmitter device is authenticated at the receiver device in the case that a positive comparative result was detected in all steps g) and otherwise an authentication is refused at the receiver device.

16. The method according to claim 1, wherein identification data is provided prior to the first performance of steps f) and g).

17. The method according to claim 16, wherein the identification data is provided to the transmitter device for the authentication device and/or the receiver device.

18. A system with a transmitter device, a receiver device and an authentication device, wherein the system is configured to carry out the method according to claim 1.

19. A device configured to perform the steps of the method according to claim 1, which are based on a receiver device, an authentication device, or a transmitter device, in steps d) to g).

20. A non-transitory computer-readable medium storing processor-executable instructions that cause a processor to perform the method according to claim 1, which are based on a receiver device and/or a transmitter device as well as preferably an authentication device, in steps d) to g).
